(19) United States
(12) Patent Application Publication
(10) Pub. No.: US 2026/0326762 A1
(43) Pub. Date: Oct. 22, 2026

(54) VEHICLE PLATOON CONTROL SYSTEM FOR SLOPES AND CURVES

(71) Applicant: HERE GLOBAL B.V., EINDHOVEN (NL)

(72) Inventors: Lauri Aarne Johannes Wirola, TAMPERE (FI); Henri Nurminen, TAMPERE (FI); Marko Luomi, TAMPERE (FI); Petri Rauhala, TAMPERE (FI)

(73) Assignee: HERE GLOBAL B.V., EINDHOVEN (NL)

(21) Appl. No.: 19/180,140

(22) Filed: Apr. 16, 2025

(51) Int. Cl. B60W 30/165; B60W 30/14; G08G 1/00

(52) U.S. Cl. CPC B60W 30/165; B60W 30/143; G08G 1/22; B60W 2552/15; B60W 2552/30; B60W 2554/802; B60W 2556/40; B60W 2556/50; B60W 2556/65

(57) ABSTRACT

A system, method, apparatus, etc. for controlling a platoon of vehicles comprising receiving location data for at least a first vehicle of the platoon of vehicles; map matching the location data for the first vehicle to a road network, and identifying a slope or a curve in the road network in response to the matched location data, wherein the slope exceeds a road grade threshold or the curve exceeds as road curve threshold. The system, method, apparatus, etc. may then calculate, by a processor, a distance to the slope or curve for the first vehicle of the platoon of vehicles; and then calculate, by the processor, a platoon command, wherein the order of vehicles or spacing between at least two vehicles in the platoon is modulated within the distance to the slope or curve for the first vehicle of the platoon.

### FIELD

The following disclosure relates to the control of vehicle platoons in relation to one or more hill or curve.

### BACKGROUND

The Global Positioning System (GPS) or another global navigation satellite system (GNSS) provides location information to a receiving device anywhere on Earth as long as the device has a substantial line of sight without significant obstruction to three or four satellites of the system. Highly automated driving (HAD) and autonomous driving technology utilize GNSS data to automate various driving tasks.

HAD and autonomous driving technologies may be used in platooning in which vehicles are organized into groups or platoons on a roadway. The platoons may be groups of buses for public transportation, groups of trucks for shipping, or groups of passenger vehicles that are associated with each other. Challenges arise in platooning vehicles in HAD and autonomous driving technologies that may be improved with specialized algorithms for controlling the platoon vehicles.

### BRIEF SUMMARY

A system, method, apparatus, etc. for controlling a platoon of vehicles, the method comprising receiving location data for at least a first vehicle of the platoon of vehicles; map matching the location data for the first vehicle to a road network; identifying a slope or a curve in the road network in response to the matched location data, wherein the slope exceeds a road grade threshold or the curve exceeds as road curve threshold; calculating, by a processor, a distance to the slope or curve for the first vehicle of the platoon of vehicles; calculating, by the processor, a platoon command, wherein the order of vehicles or spacing between at least two vehicles in the platoon is modulated within the distance to the slope or curve for the first vehicle of the platoon.

In some embodiments, the spacing between at least two vehicles in the platoon may be modulated by increasing or decreasing the gap between the vehicles. The order of vehicles of the platoon may also be modulated by moving the first vehicle further back in the platoon.

In some other embodiments calculating the distance to the slope or curve may comprise calculating a platoon length based on a quantity of vehicles in the plurality of vehicles, one or more vehicles lengths, a quantity of gaps between vehicles, and one or more gap distances. The platoon command may also instruct at least two vehicles to adjust speed in some cases.

In yet other embodiments, the platoon command may instruct the first vehicle to send a driving command to the second vehicle or another vehicle of the platoon of vehicles. In some cases, the first vehicle may be the lead vehicle of the platoon of vehicles and the lead vehicle control may be transferred to another vehicle in the platoon.

In some embodiments, the road grade threshold may be predefined or dynamic; the road curve threshold may be predefined or dynamic. The distance to the slope or curve may also be predefined or dynamic.

In yet other embodiments, a slope and a curve in the road network may be identified in response to the matched location data, wherein the slope exceeds a road grade threshold, and the curve exceeds as road curve threshold.

Another embodiment may be a non-transitory computer readable medium including instructions to perform the method above.

### BRIEF DESCRIPTION OF THE DRAWINGS

Exemplary embodiments of the present invention are described herein with reference to the following drawings.

FIG. 1A illustrates an example system for controlling a platoon of vehicles.

FIG. 1B illustrates a hierarchical chain of communication for an example system for controlling a platoon of vehicles.

FIG. 2 illustrates an example system for controlling a platoon of vehicles directly from a central controller.

FIG. 3 illustrates an example system for controlling a platoon of vehicles through a lead vehicle.

FIG. 4 illustrates an example flow chart for the system for controlling a platoon of vehicles.

FIG. 5A illustrates an example of a vehicle platoon.

FIG. 5B illustrates an example of a vehicle platoon approaching a hill.

FIG. 6 illustrates an example of a vehicle platoon approaching a curve.

FIG. 7 illustrates an exemplary vehicle of the system.

FIG. 8 illustrates an example server.

FIG. 9 illustrates an example flowchart for the server.

### DETAILED DESCRIPTION

With the improvements of HAD and autonomous driving technology development, vehicle platoon systems including truck platoon systems have become a focus in the industry. Vehicle platoon systems may reduce fuel consumption, increase the capacity of roads and provide a steady state traffic flow. These factors may bring a huge economic effect.

A vehicle platoon is a group of vehicles that are coordinated in a group. The vehicle platoon may maintain specific distances between vehicles, specific speeds, or a specific pattern or arrangement (e.g., nose-to-tail line) of vehicles. The vehicle platoon may be controlled through vehicle-to-vehicle communication or through communication with a central controller.

A vehicle platoon system may have one lead vehicle. The lead vehicle may transmit commands to other vehicles in the platoon. The lead vehicle may travel at the beginning or head of the pattern of the platoon. The lead vehicle is followed by a series of vehicles (e.g., follower vehicles) that may closely maintain the speed, distance, and maneuvers of the lead vehicle. The lead vehicle could authorize a vehicle driving nearby to join the platoon system by accepting the join platoon request or dissociate a vehicle in the vehicle platoon system by approving the dissociation request.

The early phase of a vehicle platoon system may require the vehicle driver to fulfill the operation command, but eventually while to the autonomous driving stage all vehicles may be able to automatically cooperate with the driving strategy instructions like join or leave platoons.

The vehicle platoon control system allows the vehicle platoon to maintain a cohesive group or formation by predicting and adjusting the vehicle platoon so that hills, slopes, curves, etc. do not interrupt the group or formation. Maintaining the cohesion of the platoon improves the fuel consumption because vehicles are maintained at a nearly constant speed by reducing fluctuations in acceleration and deceleration, which decrease fuel efficiency in conventional driving. Additionally, maintaining the cohesion of the platoon improves the fuel consumption because smaller distances may be maintained between the vehicles which improves the reduction in drag. Also, the vehicle platoon may reduce congestion and traffic-smaller spaces between vehicles and constant speeds mean that more vehicles fit on a given stretch of roadway, which reduces congestion. Finally, the vehicle platoon improves safety of passengers of the vehicle platoon and nearby vehicles / pedestrians.

The vehicle platoon control system is in the technological field of navigation. Improvements to navigation include the simplification of navigation instructions for maintaining the cohesion or pattern of the platoon group. When a platoon separates, additional routing is required to bring the platoon back together. When the platoon is maintained this additional route data usage is avoided. The efficiency of the navigation computers is improved because fewer calculations are needed when interruptions in the platoon are avoided. The vehicle platoon control system is in the technological field of traffic control in that navigation of a hill or curve is improved. Improved navigation of a hill or curve improves fuel efficiency of the vehicles that are maintaining greater speeds.

As described above, though a vehicle platoon system may bring many benefits like a decrease in fuel consumption and an improvement in traffic flow for autonomous vehicle platoon systems. For vehicle platoons, driving along roads with large hills, curves, etc. while maintaining the benefits of a platoon is an existing technical challenge.

The following embodiments establish a specific algorithm to control an autonomous vehicle platoon system, or another type of platoon, to successfully drive through these road sections, geometries, etc.

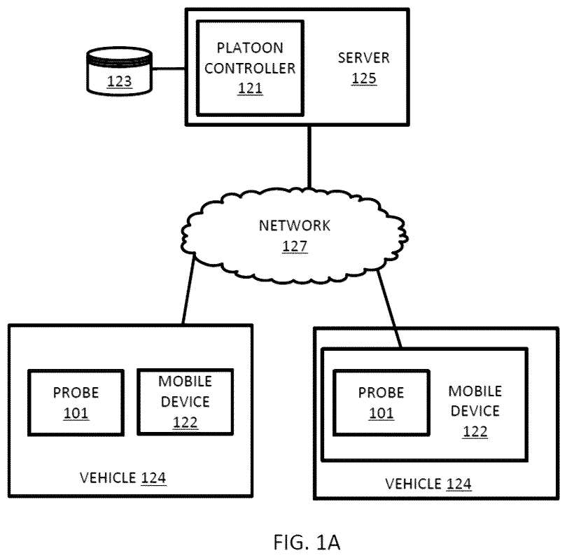

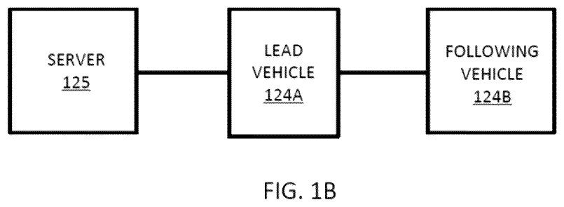

FIG. 1A illustrates an example system for controlling a platoon of vehicles. In FIG. 1, one or more vehicles 124 are connected to the server 125 though the network 127. The vehicles 124 may be directly connected to the server 125 or through an associated mobile device 122. A map developer system 121, including the server 125 and a geographic database 123, exchanges (e.g., receives and sends) data from the vehicles 124. The mobile devices 122 may include local databases corresponding to a local map, which may be modified according to the server 125. The local map may include a subset of the geographic database 123 and are updated or changed as the vehicles 124 travel. The mobile devices 122 may be standalone devices such as smartphones or devices integrated with vehicles. Additional, different, or fewer components may be included.

Each vehicle 124 and/or mobile device 122 may include position circuitry such as one or more processors or circuits for receiving GNSS signals and comparing the GNSS signals to a clock to determine the absolute or relative position of the vehicle 124 and/or mobile device 122. The mobile device 122 may act as probe 101 for determining the position or the mobile device 122 and the probe 101 may be separate devices. The absolute or relative position may be stored as location data. The location data may include geographic coordinates (e.g., longitude and latitude) or include one or more distances from the front of the platoon or the lead vehicle of the platoon. In one example, the relative location data is distance measured in two dimensions (e.g., the x and y directions), and in another example, the relative location data is distance measured in one dimension (e.g., the direction of the road segment).

The server 125 receives the location data from at least one and up to all of the vehicles 124 in the platoon of vehicles. The server 125 may receive the location data from only the lead vehicle in the platoon of vehicles (or any, or all of, the vehicles).

The platoon of vehicles may be defined in a variety of techniques. The platoon of vehicles may be an ad hoc platoon formed on the fly. That is, the vehicles may have no previous affiliation and may form the platoon according to their destination or according to user instruction. In one example, the vehicles are grouped in the platoon according to their destination. The server 125 may receive destination information from multiple vehicles and assign vehicles with the same or nearby destinations to a platoon. Assigning the vehicles to a platoon may involve sending driving commands (e.g., steering and/or speed adjustments) to the vehicles to create the platoon formation. In another example, the driver or passenger of a vehicle may request to join an existing platoon, and in response, the server 125 may send driving commands to cause the vehicle to join the platoon, and subsequently to maintain the platoon formation. In another example, the platoons may be formed before driving the route according to a specific purpose. The platoon may be made up of a series of cargo trucks such as package or parcel delivery. The platoon may be made up of mass transit vehicles holding many passengers. The platoon may be touring vehicles (e.g., sightseeing). The platoon may be made of vehicles from the same or associated manufacturers being delivered to a dealership. In another example, the vehicles may be eligible to form the platoon only when they are from the same manufacturer or use the same navigation device.

The lead vehicle may be defined in a variety of techniques. In one example, the lead vehicle is the only vehicle in the platoon that communicates with the server 125. For example, only the lead vehicle is configured for communication with the server 125 and/or for sending the location data to the server 125. In another example, more than just the lead vehicle is configured for communication with the server 125 but the lead vehicle identifies itself in the communication. For example, a message including the location data may include a lead vehicle identifier (e.g., an alphanumeric value in a vehicle identifier field or a flag) that identifies the sender of the message as the lead vehicle. In another example, the server 215 may ping the lead vehicle based on a particular IP (internet protocol) address or vehicle communication address. That is, the server 215 may request location data from only lead vehicles. As mentioned below, the lead vehicle may, in some cases, be swapped out (dynamic platoon reorganization) by the system to best (most efficiently) handle hills, curves, etc.

The server 125 is configured to analyze the location data to map match the location data to geographic data from the geographic database 123. The platoon controller 121 may query the database 123 for the road network. The platoon controller 121 may access a geographic region based on the location data as a rough estimate. The platoon controller 121 may more precisely match the location data to a particular roadway or road segment by comparing the location data to the data from the database 123. Such map matching may include identifying the closest road segment to the location data. For example, the platoon controller 121 may calculate a perpendicular distance to multiple road segments. The perpendicular distance to a road segment may be the length of a line that intersects the geographic point of the location data received from one or more vehicles 124 and connects to the road segment and meets the road segment at a right angle. The platoon controller 121 may calculate the perpendicular distance for each of a set of potential road segments and select the closest road segment to map match the location data to that road segment.

Subsequent to or in response to map matching the location data to the road segment, the platoon controller 121 identify upcoming curve(s), hills, slopes, inclines, declines, etc. for the road segment matched to the location data. The platoon controller 121 may identify the direction of the vehicle, which may be from additional heading data collected at the vehicle from a compass or another sensor, or from a series of location data values. The upcoming hills or curves may be the next road segment in the direction of travel of the vehicle 124. The upcoming hill or curve may correspond to the node at the end of the road segment. In another example, the hill or curve may be identified from the route data. In this case, the upcoming platoon obstacle may not connect to or be associated with the matched road segment. It should be noted a hill or curve may also be identified by probe data from end user vehicles or devices such as a camera, gyroscope, etc.

The platoon controller 121 may calculate a distance to the hill or curve for the platoon of vehicles. The platoon controller 121 may also identify the speed of the platoon or the lead vehicle (or any of the platoon vehicles). The platoon controller 121 may calculate a travel time based on the distance to the hill or curve. The travel time may be computed by dividing the distance to the hill or curve by the speed of the vehicle(s).

The speed may be measured from a series of location data values. The speed may be the speed that the vehicle 124 has been set to travel. The speed may be estimated from one or more attributes of the road segment such as the average speed traveled on the road segment or the speed limit of the road segment. Different levels of granularity or accuracy may be used for different types of hills, curves, slopes, etc.

The platoon controller 121 may then generate a platoon command in response to the various data points provided (location data, road data, vehicle data, platoon data, etc.). The platoon command may instruct the platoon to speed up, for example, when a large hill is upcoming. The platoon command may instruct the platoon to slow down, for example when a large curve or decline is approaching. The platoon command may control one or more of the vehicles within the platoon and adjust the distance between said vehicles (e.g., the gap(s) between the platooned vehicles). Speed may be controlled by any functional means in this example including vehicle brakes, drafting, coasting, or easing of the accelerator.

In addition, and/or in the alternative, the platoon controller 121 may generate an advisory message including the type of upcoming platoon obstacle (e.g., hill, curve, etc.), the time to the obstacle, and any navigation or control adjustments associated with platoon management (e.g., speed up, slow down, re-organize).

FIG. 1B illustrates a hierarchical chain of communication for an example system for controlling a platoon of vehicles. The example of FIG. 1B includes the server 125, a lead vehicle 124A and a following vehicle 124B. There may be many following vehicles. The term “following” refers to the general pattern of the platoon in which one vehicle follows another vehicle. In other examples, these vehicles may be referred to as platoon vehicles, linked vehicles, or member vehicles. In some examples, the server 125 communicates with all of the vehicles in the platoon including the lead vehicle 124A and the following vehicle 124B. In other examples, the server 125 only communicates with the lead vehicle 124A, which relays information to the following vehicles. Many other arrangements are possible.

Each of the following vehicles may take navigation and/or maneuver instructions from the lead vehicle 124A. Alternatively, each of the following vehicles may follow the vehicle directly in front of the respective following vehicle.

The platoon commands and platoon messages from the platoon controller 121 may be transmitted from the server 125 to the lead vehicle 124A. Alternatively, the platoon controller 121 may send the platoon commands and platoon messages directly to the following vehicles.

The platoon command may provide a navigation instruction that is applied by the vehicles or a driving instruction that is applied by the vehicles. The platoon command instructs the first vehicle to send a driving command to the second vehicle or another vehicle of the platoon of vehicles. The platoon command may be directly implemented by each vehicle. The platoon command may be interpreted by the vehicles which in turn generate the driving commands.

The navigation instructions may adjust the route. For example, the route may have originally passed through one or more large hills or curves, with a flatter road trajectory preferred for maintaining a platoon.

The driving instruction may cause the vehicles to adjust speed or apply a maneuver. Adjusting speed may include applying a brake or changing a throttle (e.g., accelerating or decelerating). The driving instruction may be selected to delay or speed up the time at which the vehicle will reach the hill or curve.

The driving instruction may include a maneuver. Example maneuvers include changing lanes. The platoon command may instruct the vehicles to change formation. Changing the formation may include changing the gap size between the vehicles. The platoon becomes smaller as the gap size is reduced. The gaps may be different sizes between different vehicles. Changing the formation may include change the number of rows or lanes that the platoon uses. For example, a single lane of 12 vehicles takes more time to traverse a hill than three lanes of 4 vehicles.

Communication between the vehicles 124 and/or between the mobile device 122 and the server 125 through the network 127 may use a variety of types of wireless networks. Example wireless networks include cellular networks, the family of protocols known as WiFi or IEEE 802.11, the family of protocols known as Bluetooth, or another protocol. The cellular technologies may be analog advanced mobile phone system (AMPS), the global system for mobile communication (GSM), third generation partnership project (3GPP), code division multiple access (CDMA), personal handy-phone system (PHS), and 4G or long term evolution (LTE) standards, 5G, DSRC (dedicated short range communication), or another protocol.

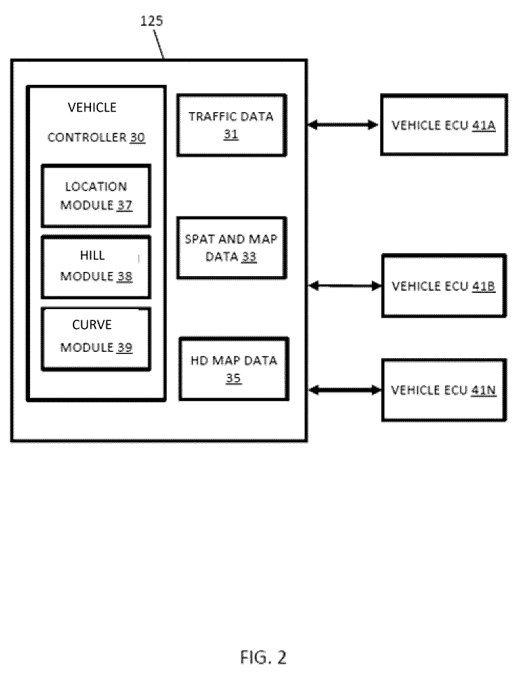

FIG. 2 illustrates an example system for controlling a platoon of vehicles directly from a central controller such as the vehicle controller 30. The vehicle controller 30 may communicate with one or more modules that receive, sort, and analyze different types of data from different sources. For example, the server 125 may include a traffic data module 31, a SPaT and MAP data module 33, and an HD map data module 35. The vehicle controller 30 may include a location module 37, a hill module 38, and a curve module 39. As discussed below, the controller 30, through the location module, is configured to receive location data for at least a first vehicle of the platoon of vehicles. As discussed below, the controller 30, by way of the hill module 38 and/or the curve module, is configured to match the location data for the vehicle to the road network stored in the geographic database 123. As discussed below, the vehicle controller 30, through its various modules is able to identify obstacles for a platoon in the form of hills or curves and adjust the platoon as needed to best navigate the obstacles.

Each of the modules may be implemented by a separate control circuit such as an integrated circuit. The controller 30 may be in communication with each of the vehicle electronic control units (ECU) 41A-N. The vehicle controller 30 may perform any or all of the operations described with respect to platoon controller 121 herein. In some embodiments, the ECU and vehicle controller 30 may be the same device while in others, the system may have disparate computing devices the communication with one another.

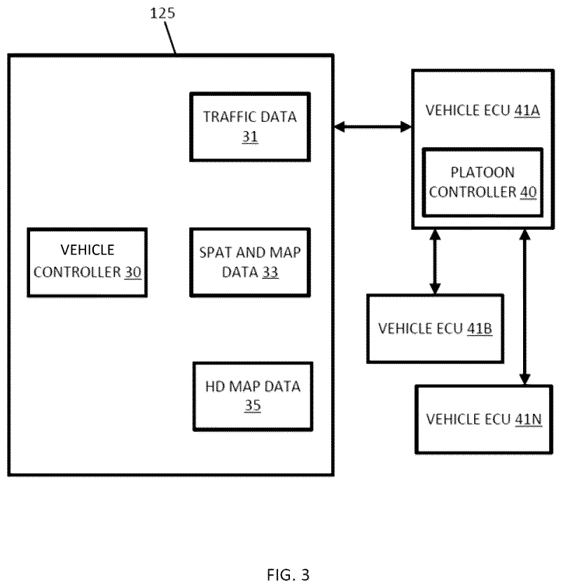

FIG. 3 illustrates an example system for controlling a platoon of vehicles through a lead vehicle. The server 125 and the vehicle controller 30 communication with the ECU 41A of the lead vehicle, which in turn issues commands to the other vehicle ECUs 41B-N using vehicle to vehicle (v2v) communication in order to broadcast the driving strategy. While driving on the road segment, the lead vehicle continuously or periodically receives the traffic data, incident data, HD map data, and traffic light (SPaT) data from the backend cloud system (e.g., server 125).

The engine control unit may be configured for other operations in the vehicle including coordination of starting the ignition, adjusting the throttle, receive commands from the user (e.g., steering, acceleration), monitoring the system of the vehicle, or other functions.

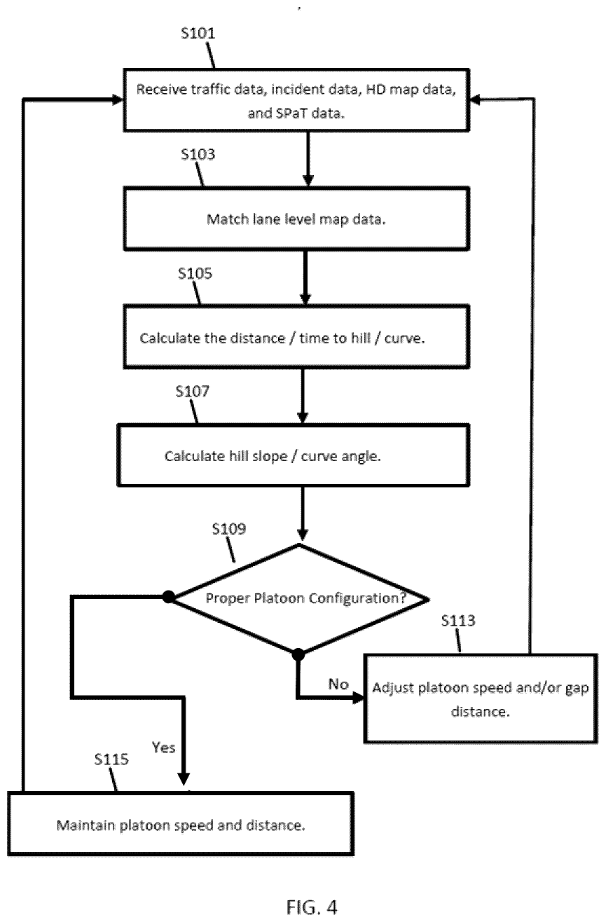

FIG. 4 illustrates an example flow chart for the system for controlling a platoon of vehicles approaching a hill (or curve, or both). The process may deviate depending on the requirements of various system instances. At act S101, the vehicle controller 30 or the traffic data module 31, the SPaT and MAP data module 33, and the HD map data module 35 may receive traffic data, HD map data, and SPaT data. Probe data may also be included.

The traffic data module 31 may coordinate the exchange of information with a traffic service, which may be a traffic server configured to collect and distribute traffic data. The traffic data may be collected from multiple sources through observation or automatic sensors. For example, the sensor data for the traffic data may be collected by mobile devices and/or vehicles. The traffic data module 31 may organize and interpret the traffic data for the vehicle controller 30. The traffic data module 31 may analyze the traffic data and identify portions of the traffic data that are relevant for a particular geographic region, roadway, intersection, etc.

The system may calculate the travel time to the hill using the traffic data. The calculation of the travel time may be based on vehicles traveling the same road or roads to the hill at the same time or recently. The system may determine the slope of the approaching hill(s) which can have little to no effect on the platoon (e.g., below a grade threshold) or a platoon obstacle (e.g., slope grade above a threshold).

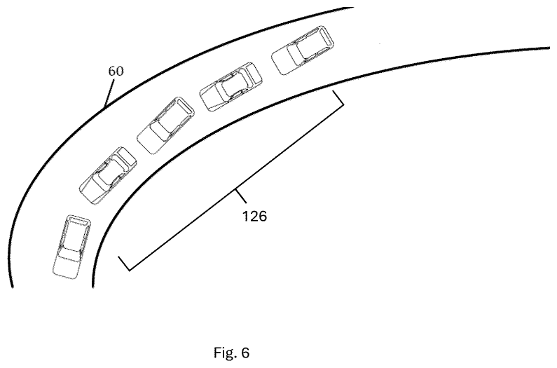

Data on the grade, height, slope, etc. of a given hill may be determined from road network data, probe data, etc. For example, topographical data regarding a road network may indicate that the given roadway will slope upwards at a predefined grade. In the USA, federal regulations state highways must have the following maximum road grade; level terrain: 4% for rural highways and 3% for freeways and expressways, rolling terrain: 5% for rural highways and 4% for freeways and expressways, mountainous terrain: 7% for rural highways and 6% for freeways and expressways. Typically, a grade of greater than 15% is considered problematic for a normal consumer vehicle engine to operate properly. The data regarding slope, etc. of the hill may be used by the system to determine if the current platoon configuration is ideal. This same approach may be used for curved roadways as well (see FIG. 6).

In some embodiments, the SPaT and MAP data module 33 may coordinate the exchange of information with an intelligent transportation system (ITS), which may be an ITS server configured to collect and distribute data for intersections (potentially on or near a hill or curve). In general, each traffic light in an intersection has an assigned SPaT control strategy. Such information about the intersection may be used by autonomous vehicles, navigation systems, traffic service providers and traffic management agencies to provide additional opportunities utilizing this information.

The Society of Automotive Engineers (SAE) J2735 standard for Dedicated Short Range Communications (DSRC) Message Set Dictionary defines a SPaT format that may be used to describe the current state of a traffic signal system for an intersection and the phases corresponding to the specific lanes in the intersection. This SPaT information may be delivered to a vehicle or navigation system through a DSRC or cellular network as the vehicle is approaching an intersection or is within a certain distance. This SPaT information may be delivered to the SPaT and MAP data module 33 of the server 125.

Vehicle platoon management through traffic lights and intersections as disclosed in U.S. Pat. No. 11,747,827B2 is incorporated herein by reference.

The MAP message provides intersection and roadway lane geometry data for one or more locations. The geometry data may include boundaries, dimensions, or other attributes that make up the intersections or roadways associated with the hill or curve. Additional roadway attributes for the intersection may be included for turn restrictions for particular lanes or what maneuvers are legally allowed at a given point may be included in the MAP message. For clarification, it should be pointed out that “MAP” may refer to the mapData from the ASN.1 definitions of SAE J2735, but other lane level geometry message may be used. This document uses capitalized “MAP” to refer to these data types and “map” for the road network type of maps.

The HD map data module 35 may coordinate the exchange of information with the geographic database 123, which may be a cloud service (i.e., data stored at another location or with server 125). The HD map data module 35 may request map data from the geographic database 123 in response to the changing location of the mobile device 122 or the vehicle 124. The HD map data may be used to map match the location data to identify the one or more upcoming hills or curves.

At act S103, the vehicle controller 30 matches the lane level map data with the location of the vehicle 124 or mobile device 122. The location data detected at the vehicle 124 is compared to the HD map data to determine the road segment and direction that the vehicle 124 is traveling. In addition, the map matching may include vehicle positions on road network with resolution of lane level (left turn lane, right turn lane, straight forward lane). The controller 30 may also match the road segment to the MAP message to determine the geometry of characteristics of the road segment and direction that the vehicle 124 is traveling. The vehicle controller 30 may also match the road segment to the SPaT data to determine relevant intersection information, etc.

At act S105, the vehicle controller 30 may calculate the distance and time to a hill or curve. The distance may be the arithmetic or geometric distance between the location data detected at the vehicle 124 and the geographic location of the hill or curve. The time to the hill or curve may be calculated by the current speed of the vehicle 124 or may be based on traffic data, probe data, etc.

At act S107, the vehicle controller 30 may calculate a time to reach the hill or curve. This is important as the platoon may be adjusted or rearranged to best navigate a given hill or curve. The time to reach a hill may be based on various factors including the length of the platoon and/or the time to reach the hill for the first or last vehicle in the platoon. The controller 30 may calculate a platoon length based on a quantity of vehicles in the platoon, one or more vehicles lengths, a quantity of gaps between vehicles, and one or more gap distances. The length of the platoon may be calculated for a single lane platoon having n vehicles spaced at uniform gap distances according to Equation 1:

Platoon length=(n*vehicle length+(n−1)*gap distance) Eq. 1

Equation 1 may be modified for different types of platoons. For example, if the gap distances between vehicles is variable, another term is added to Eq. 1. If the platoon travels in multiple rows or lanes at a time, another term that divides by the number of lanes, or otherwise reduces the platoon length, is added to the Eq. 1. If the vehicles have different lengths, the vehicle length variable is adjusted. The gap distance may be even throughout the platoon (e.g., 5 meters between each car) or vary between each vehicle. Adjustment may also be done uniformly between all vehicles in a platoon or each vehicle gap adjusted individually.

At act S109, the controller 30 determines whether the hill or curve can be passed by the platoon without interrupting the formation of the platoon or if the efficiency of the platoon traveling over the hill is optimized. This is illustrated with the phrase, “Proper Platoon Configuration?” which can mean the gap distance between cars and or the organization of the overall platoon. For example, if a large truck is leading the platoon, it may struggle up a steep slope as compared to a smaller, more aerodynamic coupe. The system may determine it is best to move the coupe ahead of the truck for a more efficient navigation of the slope. The system may then generate one or more control signals to reorganize the platoon.

At act S113, the vehicle controller 30 determines that the current platoon configuration was not adequate to safely or efficiently pass the hill or curve and generates a command to adjust platoon speed and/or gap distance, which is sent to the lead vehicle(s) to relay to the following vehicles or is sent directly to the following vehicles. At act S115, vehicle controller 30 determines that the platoon may safely and/or efficiently pass the hill or curve and in response, does nothing. Alternatively, the controller 30 may generate a command to maintain platoon speed and distance, which is sent to the lead vehicles to relay to the following vehicles or is sent directly to the following vehicles. Alternatively, the controller 30 may notify the other vehicles directly of various commands/adjustments.

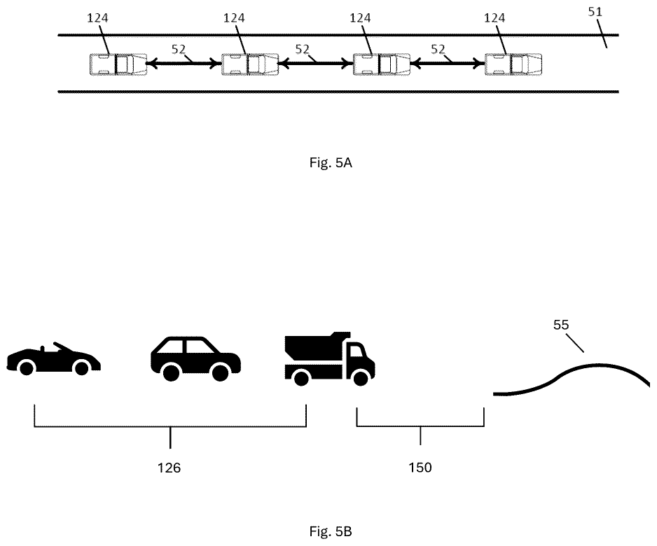

FIG. 5A illustrates an example platoon of vehicles 124 which are spaced apart by a gap distance 52 and traveling in lane 51. As shown, the gap distance (e.g. 3 meters, 5 meters, etc.) between each vehicle 124 may be maintained by the system and its various modules and/or controllers. As the platoon travels down the roadway, the lead car (or any of the cars, traffic cams, etc.) may observe the upcoming roadway via various probes such as camera systems, gyroscopes, etc. The location of one or more hills, curves, etc. may also be identified via map data stored in one or more databases. As mentioned previously and shown below, when an obstacle for the platoon (e.g., a hill or curve) is approached the system may alter the gap distance 52 to best navigate the obstacle. The order of vehicles 124 in the platoon may also be altered depending on various data and metadata about the various vehicles such as size, weight, vehicle performance data, make, model, etc.

As mentioned throughout this disclosure, the system may adjust the platoon to best navigate a hill or curve. The best or most ideal platoon configuration may be determined by the system based on various data points such as those related to safety, fuel economy, speed, etc. The system may, in some cases, maintain or access one or more databases of historical data related to crashes involving platoons. If, for example, platoons of over a certain length are more likely to be involved in a crash on a hill or curve, the system may reduce the overall platoon length to avoid this potentially dangerous platoon configuration. In the example above, the platoon may also be split momentarily by the system to more safely navigate a hill or curve, with the platoon being rejoined as one once the hill or curve is successfully navigated. For example, a leading large truck may be sent to the back of a platoon while smaller vehicles navigate the hill together, with the large truck rejoining the platoon on flatter ground.

Similar to the database(s) of safety data, the system may also examine databases related to platoon performance to determine the ideal/optimized spacing when navigating various obstacles to maximize fuel efficiency and/or speed. Such data may be observed in real time or, for example, estimated by the various OEM data for the various vehicles in a given platoon.

It should be noted that the gap distances, platoon configuration, etc., may be adjusted in real time based on feedback provided to the system regarding fuel economy, platoon speed, etc.

FIG. 5B illustrates an example platoon 126 of vehicles approaching a hill 55. As shown, platoon 126 is made up of a truck, sedan, and convertible. In this example, the truck is the lead platoon vehicle and the platoon is approaching the hill 55 along a roadway with a distance 150 within which the platoon may be adjusted or reconfigured to best navigate the hill.

As mentioned above, navigation of the hill 55 by one or more vehicle platoons 126 may be optimized in various ways by the system. Such optimization may be done by the system automatically adjusting the platoon configuration in various ways (e.g., gap distance, vehicle reorder, etc.). The platoon configuration data may, in some embodiments, be generated by one or more machine learning algorithms and/or artificial intelligence programs. The analysis of the map data, image data, audio data, and other relevant data concerning vehicle or platoon location, vehicle configuration, etc. may be carried out by a machine learning (ML) model. The ML model may utilize any functionally useful means of analysis to identify location data on a given roadway, road segment, or in a general area. The ML model may also examine relevant data about the various vehicles in a platoon such as make, model, performance data, fuel levels, height, weight, physical load (e.g., fully loaded semitruck and trailer), etc. to determine the best platoon configuration to navigate a hill or curve. The system, in this embodiment, may also examine relevant proximate points of interest (POIs), map objects, road geometries, animate/inanimate objects, etc., which could suggest potential adjustments to a platoon configuration.

Examples of machine learning models that may be trained and utilized by the system may include a decision tree model, a random forest model, a neural network, a model that employs logistic regression, or the like. In some example embodiments, the system, such as the processing circuitry, is configured to separately train a plurality of different types of machine learning models utilizing the same training data including the same plurality of training examples. After having been trained, the system, such as the processing circuitry, is configured to determine which of the plurality of machine learning models generates platoon configuration data with the greatest accuracy. The machine learning model that has been identified as most accurate/useful may thereafter be utilized.

In this example, the platoon 126 approaches the hill 55 and has around 500 meters (the pre-obstacle adjustment distance) within which to adjust the gap between the vehicles or reorder the platoon 126. The adjustment distance 150 may be predefined or dynamically determined by the system based on ML models, historical data, etc. For example, the system may determine the maximum adjustment distance 150 needed for any hill encountered by the system (e.g., 100 meters, 500 meters, etc.) and use this distance as a threshold for every adjustment. Alternatively, the adjustment distance 150 may be altered dynamically based on data such as hill slope, grade, etc. For example, if the platoon 126 is approaching a large hill or series of hills, the adjustment distance 150 may be automatically set at 1000 meters for safety and/or efficiency. Alternatively, if the hill being approached is relatively small, lower grade/lower slope the adjustment distance 150 may be set at much shorter (e.g., 250 meters).

As mentioned above, the system may also set a predefined or static road grade threshold. This threshold may be set at a certain level of road grade as, below this threshold, there is no benefit to adjusting the platoon configuration. For example, below 1% grade may be considered insignificant and thus a threshold of greater than 1% road grade may be set automatically by the system to act. This threshold may also be dynamically adjusted. For example, mountainous areas have generally higher grade than generally flat areas. Thus, if an end user was driving from the Great Plains area (4% road grade maximum) in the USA into the Rocky Mountains area (6% road grade maximum), the system may alter the road grade threshold over the trip to best adjust the platoon configuration without making constant adjustments to the platoon speed, gap distance, etc.

Continuing with the example above, the system is fully envisioned to consider not just the nearest upcoming platoon obstacle (e.g., hill, curve, etc.) but also examine map data to determine what lies beyond the obstacle to best manage a given platoon. For example, as mentioned above, the roadways through the Rocky Mountains contain more than just a single uphill slope. There are many uphill, flat (e.g., a plateau), and downhill portions (as confirmed by map data such as topological information), all of which may pose a challenge to one or more vehicle platoons. Thus, the system may adjust a platoon to account for ongoing platoon obstacles along a given roadway. The system may, over time, record the best manner by which to navigate a given area for a vehicle platoon and refine this data over time.

Another example may be that of an area with rolling hills. The roadway thus has sustained uphill and downhill areas and navigation of this area may, in some embodiments, be considered a single platoon obstacle. In this example, a platoon management strategy denoted for roadways with rolling hills may be stored by the system as a default platoon configuration for this type of platoon obstacle, with adjustments made to this default configuration to adjust for variances of a particular set of rolling hills.

FIG. 6 illustrates an example diagram of the system for controlling a vehicle platoon 126 at a curve 60. As mentioned previously, there are various road standards within which most road are constructed. For example, in the USA, maximum superelevation rate for road curves are as follows: Urban areas: 4% or 6%, Areas with frequent snow and ice: 6% or 8%, Well-traveled open highways: 10% to 12%, Freeways, expressways, and multilane conventional highways: 10%, Ramps, connectors, 2-lane conventional highways, and frontage roads: 12%. Such data may be used by the system to set a road curve threshold in a similar manner to the road grade threshold which the system uses to address hills. In this example, a superelevation rate for road curves of more than 3% may be set by the system to avoid overadjustment. This road curve threshold may also be adjusted over time by the system dynamically based on end user feedback, etc. As with the road grade threshold, the road curve threshold may also be adjusted dynamically along the route of a platoon 126 as it navigates urban areas, highways, etc.

In this embodiment and others, the system via its vehicle controller 30, etc. may analyze traffic data for the curve 60 (and/or hill 55) to determine the amount of space that is likely present. An estimation may be made from historical correlations between traffic levels and capacity on the curve 60 and/or hill 55. The traffic data may include a traffic level (e.g., low, medium, high, or additional levels), and the system may account for other vehicles on the roadway which might hinder the platoon 126. For example, the lead vehicle may make observations using one or more sensors to determine whether the curve 60 has capacity for the platoon. A sensor such as a camera, a light detection and ranging (LiDAR) device, or a radar device may collect measurements of the state of the traffic on the curve 60. When the sensor data indicates that there is capacity on the curve 60, the platoon is maintained, (e.g., the speed of the platoon is maintained, and/or the gap distance of the platoon is maintained to continue as planned to curve 60). When the capacity is less than the number of vehicles of the platoon, the system may make an adjustment to shrink the platoon spacing (gap distance) or configuration, or even adjust the route.

It should be noted that the examples shown show a hill and a curve handled by the system separately, but it is fully envisioned the system may address both hills and curves simultaneously via the use of a road grade threshold and road curve threshold.

As mentioned above, the system may examine road data including how steep a hill is, how severe a curve or bend in the road is, etc. In some embodiments, other road data and metadata may be examined by the system. For example, data on road surface(s) may be factored into the system's assessment of optimal platoon navigation. Road surfaces may be noted as paved (e.g., asphalt or concrete) or unpaved (using materials like gravel, dirt, or earth). In some embodiments, various types of road surfaces may further be defined as Concrete roads, Asphalt roads, Gravel roads, Earthen roads, Murrum roads, Kankar roads, or Bituminous roads. Such data may be stored and updated in one or more databases accessible by the system.

In addition to road surface type, road conditions (e.g., road covered with snow) and weather conditions may also be taken into account in some embodiments. For example, driving a large commercial truck in the mountains on a snow covered gravel roadway may require very different speed and/or braking controls to safely navigate a hill or curve that of a 4×4 driving in the same conditions. Thus, in such a situation, a platoon or vehicles may be adjusted based on vehicle capability to navigate given road conditions/types of roadways.

It should be noted that weather conditions (e.g., heavy precipitation), road surface conditions (e.g., covered in ice), road surface types (e.g., gravel), etc. may be received and analyzed by the system via any useful means including vehicle probe data (such as a camera or wheel traction/slippage data) and/or from weather service data.

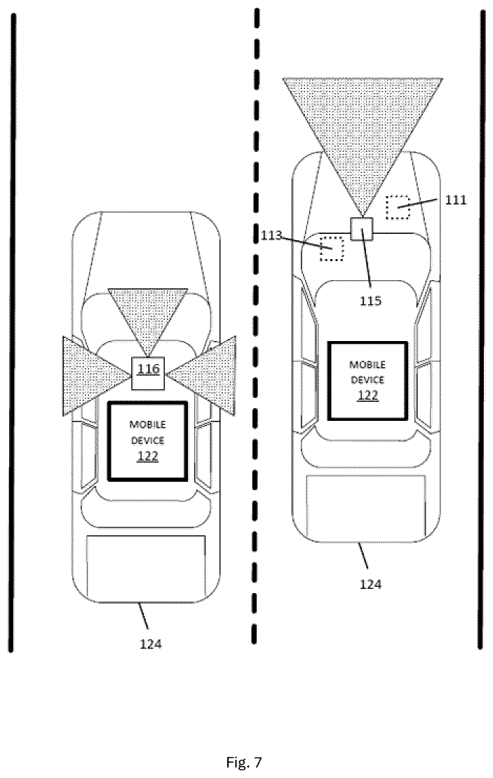

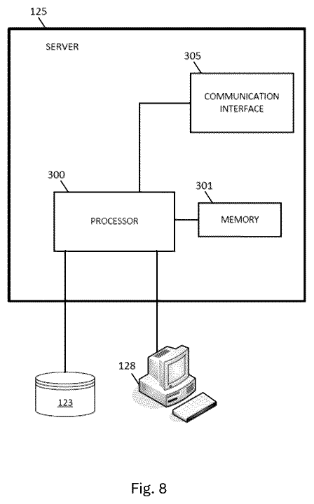

FIG. 7 illustrates an exemplary vehicle 124 of an embodiment of the platoon management system. One of the vehicles 124 may be a collection vehicle configured to collect data in the area proximate to the vehicle 124. The collection vehicle may include one or more distance data collection device or sensor, such as a light detection and ranging (LiDAR) device. The distance data collection sensor may generate point cloud data. The distance data collection sensor may include a laser range finder that rotates a mirror directing a laser to the surroundings or vicinity of the collection vehicle on a roadway or another collection device on any type of pathway. Other types of pathways may be substituted for the roadway in any embodiment described herein.

A connected vehicle includes a communication device and an environment sensor array for reporting the surroundings of the vehicle 124 to the server 125. The connected vehicle may include an integrated communication device coupled with an in-dash navigation system. The connected vehicle may include an ad-hoc communication device such as a mobile device 122 or smartphone in communication with a vehicle system. The communication device connects the vehicle to a network including at least one other vehicle and at least one server. The network may be the Internet or connected to the internet.

The sensor array may include one or more sensors configured to detect surroundings of the vehicle 124. The sensor array may include multiple sensors. Example sensors include an optical distance system such as LiDAR 116, an image capture system 115 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera or another camera.

The vehicles 124 may include a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the vehicle 124. The positioning system may also include a receiver and correlation chip to obtain a GPS signal. Alternatively or additionally, the one or more detectors or sensors may include an accelerometer built or embedded into or within the interior of the vehicle 124.

In some alternatives, additional sensors may be included in the vehicle 124. An engine sensor 111 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 113, may include a steering wheel angle sensor, a speedometer sensor, or a tachometer sensor.

A mobile device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle 124. The assisted driving device may include memory, a processor, and systems to communicate with the mobile device 122. The assisted driving vehicles may respond to geographic data received from geographic database 123 and the server 125 and driving commands or navigation commands received from the vehicle controller 30 and/or platoon controller 40.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to geographic data received from geographic database 123 and the server 125 and driving commands or navigation commands received from the vehicle controller 30 and/or platoon controller 40.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle, and may respond to geographic data received from geographic database 123 and the server 125 and driving commands or navigation commands received from the vehicle controller 30 and/or platoon controller 40.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on geographic data received from geographic database 123 and the server 125 and driving commands or navigation commands received from the vehicle controller 30 and/or platoon controller 40.

It is beneficial from an energy optimization perspective to avoid the need for braking due to the presence of a platoon obstacle (e.g., curve or downhill area) by releasing the accelerator in advance of the obstacle and letting friction and air resistance slow down a vehicle. Thus, in some embodiments, the system may utilize ADAS systems to release the accelerator ahead of a platoon obstacle to avoid the need for braking (and help optimize energy usage).

FIG. 8 illustrates an example server 125, which may apply to the system of FIG. 1. The server 125 includes a processor 300, a communication interface 305, a memory 301, and a database 123. An input device (e.g., keyboard or personal computer 128) may be used to enter settings to the server 125. Additional, different, or fewer components may be provided in the server 125.

One example for the server 125 in use is the processor 300 or communication interface 305 receiving data for an upcoming hill or curve. The communication interface 305 may be means for receiving the data. The processor 300 may include circuitry or a module or an application specific controller as a means for receiving the data. The processor 300 my then determine platoon data for a vehicle platoon traveling toward the hill or curve. The platoon data includes data indicative of the position and/or speed of the vehicle platoon. The platoon data may indicate an estimate arrival time for the platoon at the hill/curve or the distance remaining (e.g., the distance within which the platoon may be adjusted prior to reaching the obstacle). The processor 300 may include circuitry or a module or an application specific controller as a means for calculating platoon data for the platoon.

The processor 300 may then compare the hill/curve data to the platoon data to determine whether an adjustment to the platoon should be made. Adjustments to slow the platoon may include reducing the speed of the platoon, taking a detour (e.g., going around a block) along the route, altering vehicle gap distance, or changing lanes to a slower lane. Adjustments to speed up the platoon may include increasing the speed of the platoon, reducing the gap distances between vehicles (less drag), or changing lanes to a quicker lane. Another adjustment to increase the speed may include changing the pattern or order of the platoon. The processor 300 may include circuitry or a module or an application specific controller as a means for determining an adjustment to the platoon.

In this example, the processor 300 or communication interface 305 may then generate and send a platoon command message based on the adjustment(s) needed. The processor 300 may include circuitry or a module or an application specific controller as a means for generating the platoon command message. The communication interface 305 may be a means for sending the platoon command message to one or more vehicles. The processor 300 may wait for an acknowledgement message from the vehicle and send supplemental message until the acknowledgment message is received.

The memory 301 may be configured to store the hill/curve data and the platoon data. The memory 301 may store templated for the platoon commands and a lookup table for comparing the hill/curve data and the platoon data.

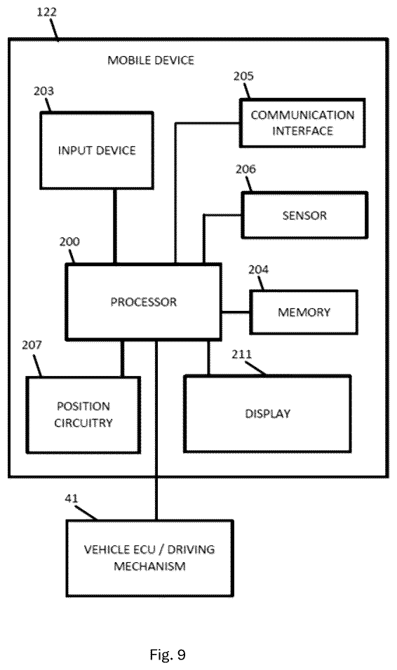

FIG. 9 illustrates an exemplary mobile device 122 of the system of FIG. 1. The mobile device 122 includes a processor 200, a memory 204, an input device 203, a communication interface 205, position circuitry 207, a distance detector 209, a display 211, and a sensor 206. The input device 203 may receive commands from the user for default settings for the platoon. The default settings may include the gap distance between vehicles, the pattern of the platoon, the types of platoon obstacles (e.g., hills or curves) to analyze, the number of vehicles in the platoon, or other settings. The processor 200 may communicate with a vehicle ECU which operates one or more driving mechanisms (e.g., accelerator, brakes, steering device). Alternatively, the mobile device 122 may be the vehicle ECU, which operates the one or more driving mechanisms directly. The sensor 206 may include a camera, a LiDAR device, or another sensor described herein. The sensor 206 may detect congestion local to the mobile device 122. The sensor 206 may detect when a hill or curve is approaching. Additional, different, or fewer components are possible for the mobile device 122.

An example of the operation of mobile device 122 is the processor 200 generating, via position circuitry 207, location data for a platoon of vehicles. The position of the lead vehicle, or any of the following vehicles, may represent the location of the platoon. The position circuitry 207 or the processor 200 detects a geographic position of the mobile device 122 or the vehicle and may send the geographic location for the mobile device 122 to a server. The position circuitry 207 is one example means for detecting or determining a geographic position. The processor 200 may also include circuity serving as means for detecting or determining a geographic position. The detected geographic position of the mobile device 122 may include a latitude and longitude pair. The geographic position may be detected or sampled at periodic intervals in time or distance, or may be continuously detected. The sensor 206, which may include distancing sensors, range sensor, image sensors, or another sensor (see FIG. 7) may also provide information for determining the geographic position of the mobile device 122.

The processor 200 or the communication interface 205 my receive, from the server, road network data, the road data indicative of any notable upcoming hills or curves which may impact performance of a vehicle platoon. Hills with a grade above a predefine or dynamic threshold (e.g., greater than 4% grade) may be observed by the system via historic data as having a significant impact on platoon performance. In such a situation, the system may set up a flag or other form of database entry for such hills in the map database and act upon this data when a given platoon approaches a hill which exceeds the predefined threshold. Large curves in the roadway may also be accounted for by the system in a similar way.

The communication interface 205 is an example for a means for receiving the hill or curve data. The processor 200 may include circuitry or a module or an application specific controller as a means for receiving the data.

The processor 200 may then perform a determination of whether the platoon of vehicles can pass the upcoming hill or curve without significant interruption in safety or efficiency. As described in examples herein, the processor 200 may calculate an estimated time for the platoon to reach the hill. The processor 200 may include circuitry or a module or an application specific controller as a means for determining whether the platoon of vehicles can pass the upcoming obstacle without issue.

The processor 200 or the vehicle ECU 41 may then generate a platoon command in response to the determination of whether the platoon of vehicles can navigate the hill or curve within acceptable tolerances (e.g., safety and efficiency). The platoon command may change the route of the platoon, change the speed of the platoon, or change the lanes the platoon travels, change the pattern of the platoon (e.g., lead car sent to the back, etc.) The processor 200 or the ECU 41 may include circuitry or a module or an application specific controller as a means for generating a platoon command.

The processor 200 or the ECU 41 may then execute the one or more platoon command(s). Alternatively, the processor 200 or the ECU 41 may instruct a driving mechanism to execute the platoon command. Example driving mechanisms include a throttle that speeds up or slows down the vehicle, a steering wheel that turns the vehicle in one or more directions, or a brake that slows the vehicle.

The processor 200 may include a routing module including an application specific module or processor that calculates routing between an origin and destination. The routing module is an example means for generating a routing command based on the platoon command. The routing command may be a route from the route to the destination. The routing command may be a driving instruction (e.g., turn left, go straight), which may be presented to a driver or passenger, or sent to an assisted driving system. The display 211 is an example means for displaying the routing command. The mobile device 122 may generate a routing instruction based on the platoon command. The routing instructions may be provided by display 211. The mobile device 122 may be configured to execute routing algorithms to determine an optimum route to travel along a road network from an origin location to a destination location in a geographic region. Using input(s) including map matching values from the server 125, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile devices 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments.

The mobile device 122 may plan a route through a road system, or modify a current route through a road system in response to the request for additional observations of the road object. For example, when the mobile device 122 determines that there are two or more alternatives for the optimum route and one of the routes passes the initial observation point, the mobile device 122 selects the alternative that passes the initial observation point. The mobile devices 122 may compare the optimal route to the closest route that passes the initial observation point. In response, the mobile device 122 may modify the optimal route to pass the initial observation point.

The mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. Non-limiting embodiments of navigation devices may also include relational database service devices, mobile phone devices, car navigation devices, and navigation devices used for air or water travel.

The controller 200 and/or processor 300 may include a general processor, digital signal processor, an application specific integrated circuit (ASIC), field programmable gate array (FPGA), analog circuit, digital circuit, combinations thereof, or other now known or later developed processor. The controller 200 and/or processor 300 may be a single device or combinations of devices, such as associated with a network, distributed processing, or cloud computing.

The memory 204 and/or memory 301 may be a volatile memory or a non-volatile memory. The memory 204 and/or memory 301 may include one or more of a read only memory (ROM), random access memory (RAM), a flash memory, an electronic erasable program read only memory (EEPROM), or other type of memory. The memory 204 and/or memory 801 may be removable from the mobile device 122, such as a secure digital (SD) memory card.

The communication interface 205 and/or communication interface 305 may include any operable connection. An operable connection may be one in which signals, physical communications, and/or logical communications may be sent and/or received. An operable connection may include a physical interface, an electrical interface, and/or a data interface. The communication interface 205 and/or communication interface 305 provides for wireless and/or wired communications in any now known or later developed format.

The databases 123 may include geographic data used for traffic and/or navigation-related applications. The geographic data may include data representing a road network or system including road segment data and node data. The road segment data represent roads, and the node data represent the ends or intersections of the roads. The road segment data and the node data indicate the location of the roads and intersections as well as various attributes of the roads and intersections. Other formats than road segments and nodes may be used for the geographic data. The geographic data may include structured cartographic data or pedestrian routes.

The databases may also include other attributes of or about the roads such as, for example, geographic coordinates, street names, address ranges, speed limits, turn restrictions at intersections, and/or other navigation related attributes (e.g., one or more of the road segments is part of a highway or toll way, the location of stop signs and/or stoplights along the road segments), as well as points of interest (POIs), such as gasoline stations, hotels, restaurants, museums, stadiums, offices, automobile dealerships, auto repair shops, buildings, stores, parks, etc. The databases may also contain one or more node data record(s) which may be associated with attributes (e.g., about the intersections) such as, for example, geographic coordinates, street names, address ranges, speed limits, turn restrictions at intersections, and other navigation related attributes, as well as POIs such as, for example, gasoline stations, hotels, restaurants, museums, stadiums, offices, automobile dealerships, auto repair shops, buildings, stores, parks, etc. The geographic data may additionally or alternatively include other data records such as, for example, POI data records, topographical data records, cartographic data records, routing data, and maneuver data.

The databases may include historical traffic speed data for one or more road segments. The databases may also include traffic attributes for one or more road segments. A traffic attribute may indicate that a road segment has a high probability of traffic congestion.

The input device 203 may be one or more buttons, keypad, keyboard, mouse, stylus pen, trackball, rocker switch, touch pad, voice recognition circuit, or other device or component for inputting data to the mobile device 122. The input device 203 and display 211 may be combined as a touch screen, which may be capacitive or resistive. The display 211 may be a liquid crystal display (LCD) panel, light emitting diode (LED) screen, thin film transistor screen, or another type of display. The output interface of the display 211 may also include audio capabilities, or speakers. In an embodiment, the input device 203 may involve a device having velocity detecting abilities.

The positioning circuitry 207 may include suitable sensing devices that measure the traveling distance, speed, direction, and so on, of the mobile device 122. The positioning system may also include a receiver and correlation chip to obtain a GPS signal. Alternatively or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 207 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 207 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122.

The position circuitry 207 may also include gyroscopes, accelerometers, magnetometers, or any other device for tracking or determining movement of a mobile device. The gyroscope is operable to detect, recognize, or measure the current orientation, or changes in orientation, of a mobile device. Gyroscope orientation change detection may operate as a measure of yaw, pitch, or roll of the mobile device.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In an embodiment, a vehicle may be considered a mobile device, or the mobile device may be integrated into a vehicle.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

The illustrations of the embodiments described herein are intended to provide a general understanding of the structure of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method for controlling a platoon of vehicles, the method comprising:
receiving location data for at least a first vehicle of the platoon of vehicles;
map matching the location data for the first vehicle to a road network;
identifying a slope or a curve in the road network in response to the matched location data, wherein the slope exceeds a road grade threshold or the curve exceeds a road curve threshold;
calculating, by a processor, a distance to the slope or curve for the first vehicle of the platoon of vehicles;
calculating, by the processor, a platoon command, wherein the order of vehicles or spacing between at least two vehicles in the platoon is modulated within the distance to the slope or curve for the first vehicle of the platoon.

2. The method of claim 1, wherein the spacing between at least two vehicles in the platoon is modulated by increasing or decreasing the gap between the vehicles.

3. The method of claim 1, wherein the order of vehicles in the platoon is modulated.

4. The method of claim 1, wherein the order of vehicles in the platoon is modulated by moving the first vehicle further back in the platoon.

5. The method of claim 1, wherein the platoon command instructs at least one vehicle to adjust speed.

6. The method of claim 1, wherein the platoon command instructs the first vehicle to send a driving command to the second vehicle or another vehicle of the platoon of vehicles.

7. The method of claim 3, wherein the first vehicle is a lead vehicle of the platoon of vehicles and the lead vehicle control is transferred to another vehicle in the platoon.

8. The method of claim 1, wherein the road grade threshold is predefined or dynamic.

9. The method of claim 1, wherein the road curve threshold is predefined or dynamic.

10. The method of claim 1, wherein the distance to the slope or curve is predefined or dynamic.

11. The method of claim 1, wherein a slope and a curve in the road network are identified in response to the matched location data, wherein the slope exceeds a road grade threshold and the curve exceeds a road curve threshold.

12. An apparatus, the apparatus comprising at least one processor and at least one memory storing computer program code, the at least one memory and the computer program code configured to, with the processor, cause the apparatus to at least:
receive location data for at least a first vehicle of the platoon of vehicles;
map match the location data for the first vehicle to a road network;
identify a slope or a curve in the road network in response to the matched location data, wherein the slope exceeds a road grade threshold or the curve exceeds a road curve threshold;
calculate, by a processor, a distance to the slope or curve for the first vehicle of the platoon of vehicles;
calculate, by the processor, a platoon command, wherein the order of vehicles or spacing between at least two vehicles in the platoon is modulated within the distance to the slope or curve for the first vehicle of the platoon.

13. The apparatus of claim 12, wherein the spacing between at least two vehicles in the platoon is modulated by increasing or decreasing the gap between the vehicles.

14. The apparatus of claim 12, wherein the order of vehicles in the platoon is modulated by moving the first vehicle further back in the platoon.

15. The apparatus of claim 12, wherein calculating the distance to the slope or curve comprises calculating a platoon length based on a quantity of vehicles in the plurality of vehicles, one or more vehicles lengths, a quantity of gaps between vehicles, and one or more gap distances.

16. The apparatus of claim 12, wherein the platoon command instructs at least one vehicle to adjust speed.

17. The apparatus of claim 12, wherein the road grade threshold is predefined or dynamic.

18. The apparatus of claim 12, wherein the road curve threshold is predefined or dynamic.

19. The apparatus of claim 12, wherein the distance to the slope or curve is predefined or dynamic.

20. The apparatus of claim 12, wherein a slope and a curve in the road network are identified in response to the matched location data, wherein the slope exceeds a road grade threshold and the curve exceeds a road curve threshold.
